(19) United States
(12) Patent Application Publication
(10) Pub. No.: US 2012/0032793 A1
(43) Pub. Date: Feb. 9, 2012

(54) VISUAL WHEEL END ASSEMBLY HIGH-TEMPERATURE WARNING SYSTEM

(76) Inventors: Frank Joseph Sonzala, San Antonio, TX (US); Mark Kevin Hennig, Corpus Christi, TX (US); Michael James McIver, San Antonio, TX (US)

(21) Appl. No.: 13/195,140

(22) Filed: Aug. 1, 2011

Related U.S. Application Data
(60) Provisional application No. 61/369,537, filed on Jul. 30, 2010.

(51) Int. Cl. G08B 21/00; B60C 23/00

(52) U.S. Cl. 340/449; 152/417

(57) ABSTRACT

A visual high-temperature warning system for a vehicle wheel-end assembly, the system comprising a thermochromic temperature indicator affixed to the wheel end assembly in heat exchange relationship therewith.

### CROSS-REFERENCE TO RELATED APPLICATION DATA

This application claims priority to U.S. Provisional Patent Application No. 61/369,537, entitled “Visual Wheel End Assembly High-Temperature Warning System” filed Jul. 30, 2010, which is hereby entirely incorporated by reference.

### FIELD

The disclosed system relates generally to visual high-temperature warning systems for vehicles.

### BACKGROUND

In the event of a failure associated with the wheel end, such as a bearing failure or brake failure, elements of the wheel end can heat up and reach high temperatures very quickly. When these high temperatures are reached by the wheel end, tires and/or lubricant may ignite and cause the wheel to lock up or the vehicle to burn. Due to the intense heat caused by a wheel end failure, it is also possible that the wheel can detach from the axle.

### SUMMARY

A high temperature warning system for a wheel end assembly rotatable on an axle on a vehicle, the system comprising an air pressure supply; a normally-closed valve in sealed fluid communication with the air pressure supply; a heat sensitive control capable of opening the normally-closed valve upon a predetermined temperature, the heat sensitive control mounted on or near the steer-axle wheel end assembly in a heat exchange relationship therewith; a warning indicator connected to the air pressure supply for actuation upon opening of the normally-closed valve; and a thermochromic temperature indicator affixed to the wheel end assembly in a heat-exchange relationship therewith, the thermochromic temperature indicator capable of changing color when heated to the predetermined temperature.

In a vehicle having an automatic tire inflation system for providing air to a rotating tire on a wheel end assembly comprising a hubcap and rotatably mounted on bearings on a hollow axle connected to an air pressure supply for supplying air to the inside of the axle, a rotary connection in communication between the tire and air inside of the axle, the combination of a high-temperature warning system comprising a normally-closed valve connected between the inside and the outside of the axle in connection with the air in the axle; a heat sensitive control connected to and actuating said valve open upon a predetermined temperature, said control mounted in a heat-exchange relationship with said wheel assembly for detecting the temperature of the wheel assembly; a warning system connected to the air supply for actuation upon opening of the valve; and a thermochromic temperature indicator affixed to the wheel end assembly in a heat-exchange relationship therewith.

An automatic tire inflation system for providing air to a rotating tire on a wheel end assembly rotatably mounted on bearings on a hollow axle, the system comprising an air pressure supply for supplying air through the inside of the axle; a rotary union configured to sealingly communicate air from the inside of the axle to the tire; and a thermochromic temperature indicator affixed to the wheel end assembly in a heat-exchange relationship therewith, the thermochromic temperature indicator capable of changing color when heated to a predetermined temperature.

A high temperature warning system for a wheel end assembly rotatable on an axle on a vehicle, the system comprising a wheel end assembly comprising a hub cap, a hub, an axle and bearings, the system comprising a temperature indicator affixed at or near the hub cap, hub, axle or bearings, and in a heat exchange relationship with at least one of the hub cap, hub, axle and bearings; wherein the temperature indicator is positioned to be visible to a user; and wherein the temperature indicator comprises a thermochromic material; and wherein the temperature indicator is capable of changing color when heated to the predetermined temperature.

### BRIEF DESCRIPTION OF THE FIGURES

FIG. 1 illustrates one embodiment of a vehicle that may use a visual wheel end assembly high-temperature warning system.

FIG. 2 illustrates the trailer axles of FIG. 1 having a visual high-temperature warning system and an automatic tire inflation system installed.

FIG. 3 illustrates a side view of one embodiment of a wheel end assembly comprising a visual wheel end assembly high-temperature warning system.

FIG. 4 illustrates a perspective view of another embodiment of a wheel end assembly comprising a visual wheel end assembly high-temperature warning system.

FIG. 5 illustrates a cross-sectional view of another embodiment of a wheel end assembly comprising a visual wheel end assembly high-temperature warning system, a high temperature warning system, and an automatic tire inflation system.

FIG. 6 illustrates a perspective view of another embodiment of a wheel end assembly comprising a visual wheel end assembly high-temperature warning system and an high temperature warning system.

FIG. 7 illustrates a cross-sectional view of another embodiment of a wheel end assembly comprising a visual wheel end assembly high-temperature warning system and a high temperature warning system.

### DETAILED DESCRIPTION

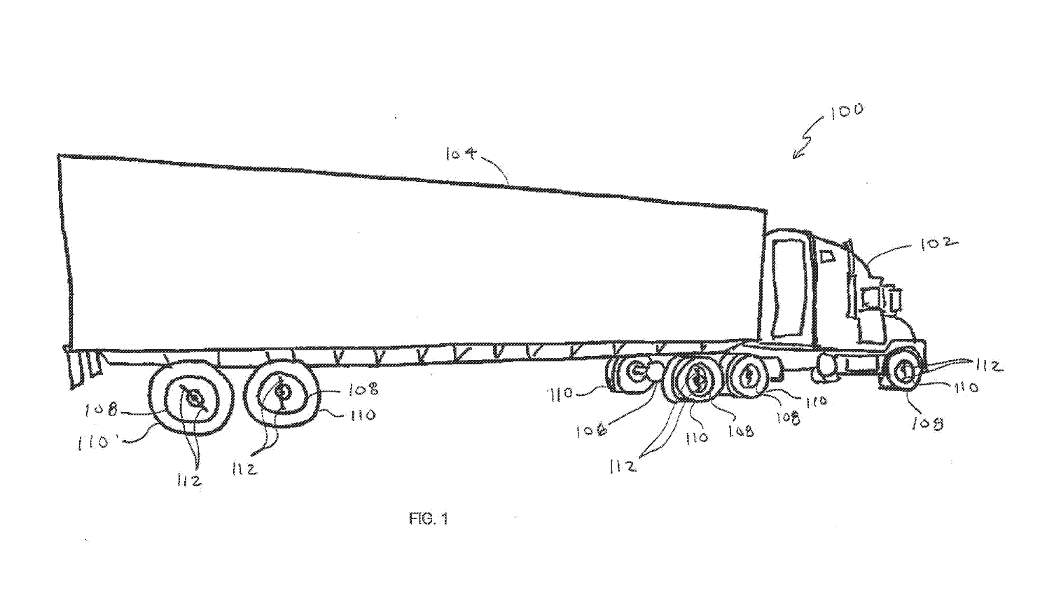

As may be seen in FIG. 1, a vehicle 100 may comprise a truck 102 and a trailer 104. The truck 102 may include one or more drive axles 106 as part of the vehicle's powertrain. The truck 102 may further include a steer axle (not shown in detail) having pivotable spindles that may provide steering capability for the vehicle 100. The trailer 104 may include one or more fixed axles (not shown). Each axle may have one or more wheels 108 mounted thereto. A pneumatic tire 110 may be mounted to each wheel 108.

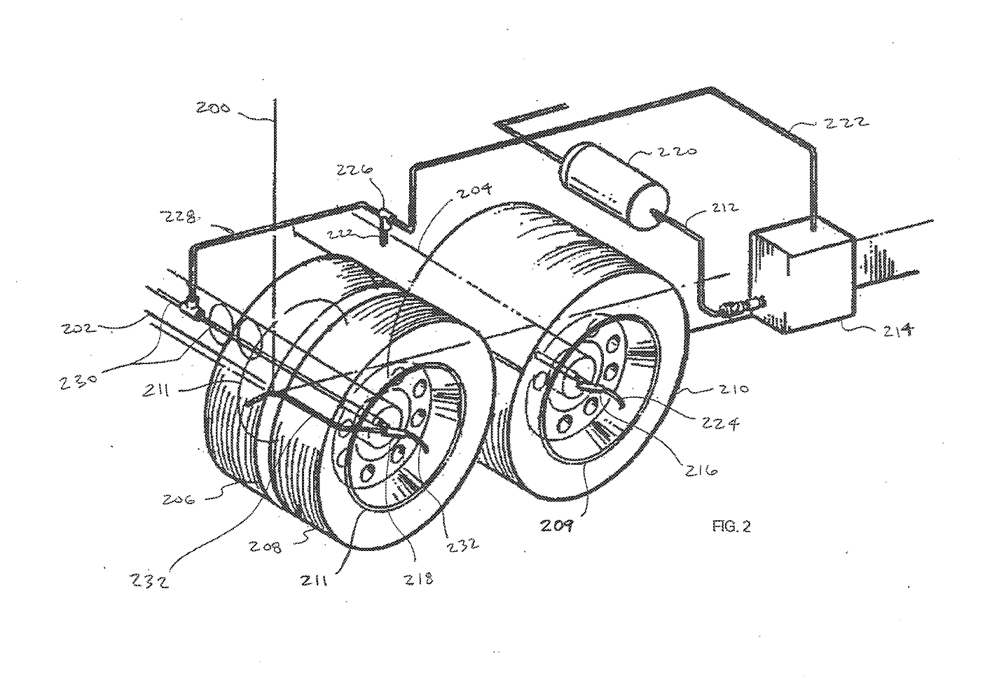

The vehicle 100 may be provided with an automatic tire inflation system (such as is shown in FIG. 2) that uses pressurized air from the vehicle's air brake system or some other source of pressurized air to maintain the tires at a desired air pressure. The automatic tire inflation system may be used to control air pressure in one or more of the tires 110 mounted to the steer (not shown), drive 106 and trailer axles (not shown). The automatic tire inflation system may include one or more air hoses 112 in fluid communication with each tire 110 for communicating air from the air pressure source to and from one or more of the tires 110.

FIG. 2 illustrates in more detail multiple embodiments of an automatic tire inflation system for trailer tires. A trailer 200 may include two axles 202 and 204. Some trailers may have dual tires 206 and 208 mounted at each end of the axles, as may be seen with respect to axle 202. Other trailers may have one wide-base tire 210 mounted at each end of the axles, as may be seen with respect to axle 204. The automatic tire inflation system may generally include a pressure regulator 214 and one or more rotary air connections or rotary unions 216 and 218 mounted in or near the axle ends. Rotary air connections may be provided in a variety of configurations, such as those disclosed in U.S. Pat. Nos. 6,105,645 and 6,698,482, and in U.S. Pub. App. No. 2009/0283190. The pressure regulator 214 may receive pressurized air from an air pressure source 220 through a conduit 212. The air pressure source 220 may comprise, for example, a vehicle air brake system air supply, or a step-up or booster pump. The pressure regulator 214 may control or reduce the air pressure from the air pressure source 220 to an air pressure level suitable for inflating the tires 206, 208, 210, such as 110 psi. Pressurized air may flow from the pressure regulator 214 through conduit 222 to the axles 202 and 204. Axles 202 and 204 may, for example, carry an air conduit to communicate pressurized air to rotary air connections 216 and 218, such as is disclosed in U.S. Pat. Nos. 6,325,124 and 7,273,082.

Axles 202 and 204 may be hollow sealed axles. In one embodiment, axle 204 may be hollow and may be sealed to serve as a conduit for pressurized air. The air conduit 222 may be sealingly connected to the axle 204 to allow pressurized air to flow from the pressure regulator 214 to the axle 204. The pressurized air may flow through the axle 204 to a rotary air connection 216 mounted in or near the spindle end as described in more detail below. An air hose 224 may be connected to the rotary air connection 216 to the valve stem (not shown) of the wheel 209 to which the tire 210 is mounted, thus allowing pressurized air to flow to and from the tire 210.

In some embodiments, the air conduit 222 may be sealingly connected to a tee 226 to allow pressurized air to flow both to axle 204 and to axle 202. An air conduit 228 may allow pressurized air to flow from the tee 226 to a conduit 230 disposed in axle 202. Axle 202 may carry an air conduit 230 to communicate pressurized air to rotary air connection 218. Air hoses 232 may connect the rotary air connection 218 to the valve stems of the wheels 211 to which tires 206 and 208 are mounted, thus allowing pressurized air to flow to and from the tires 206 and 208. In other embodiments, if the axle 202 is solid, then a channel may be bored in axle 202 to permit positioning of all or part of conduit 230 inside the axle 202.

As noted above, the axles 202 and 204 may be wholly or partially solid or hollow, and may be configured in a variety of ways. For illustration purposes only, axles 202 and 204 are hollow. For example, in some embodiments, an axle may comprise a solid beam having a spindle attached to each end (not shown). The axle spindles may be configured to allow mounting of wheel bearings upon which a hub may be rotatably mounted (not shown). In other embodiments, an axle may comprise a hollow tube having a spindle attached to each end. The spindles may be hollow, resulting in a hollow axle that is open at each end. The open end may be sealed so as to allow the hollow axle to hold pressurized air and to support air conduits or rotary air connections (or components thereof), for example, with a plug or cap disclosed in one of U.S. Pat. Nos. 5,584,949, 5,769,979, 6,131,631, 6,394,556, and 6,938,658. Alternatively, the spindles may be wholly or partially solid, resulting in a hollow axle that is closed at each end.

Similarly, automatic tire inflation systems may be used for drive axles (not shown), and air conduits or channels may be provided in the drive axles to allow air flow from a pressure regulator 214 to a rotary air connection, for example as disclosed in U.S. Pat. Nos. 5,377,736 and 7,690,412. In yet other embodiments, again with reference to FIG. 2, air conduits (not shown) may run from the pressure regulator 214 along the outside of the vehicle trailer 200, and connect to the rotary air connections 216 and 218. Thus, an automatic tire inflation system may be adapted to work with a variety of axles, whether solid or hollow, sealed or unsealed, or fixed, drive or steer.

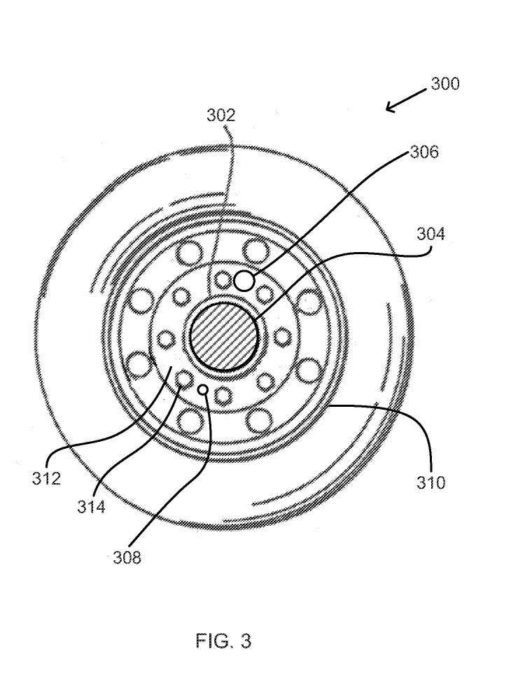

FIG. 3 illustrates a wheel-end assembly 300 similar to the wheel-end assembly mounted to axle 202 in the embodiment of FIG. 2, but without an automatic tire inflation system attached thereto, that may include a visual wheel end assembly high-temperature warning system. The visual wheel end assembly high-temperature warning system may provide a visual indication of the temperature of the wheel end assembly 300 so that a driver may determine which wheel end assembly 300 (or assemblies) has reached a predetermined temperature.

If the bearings, brakes, or other elements of the wheel end fail, the temperature in the bearings, brake drum, hub, wheel, hubcap or other wheel end components may reach in a temperature high enough to ignite the tires and bearing lubricant. Such heat may also be sufficiently high to cause the wheel end assembly to detach from the axle. The disclosed high-temperature warning system may warn the vehicle operator of high temperatures well before the tires ignite or bearings melt, or some other dangerous high-temperature related condition arises in the wheel-end. A pre-determined temperature may be, for example, a temperature well below the softening or melting point of the bearing materials, or well below the tire melting point. The pre-determined temperature may be set well above the maximum temperatures at which a wheel-end assembly may normally operate so as to avoid false indication of high temperatures.

The visual wheel end assembly high-temperature warning system may comprise a visual temperature indicator 304 that is a part of, adjacent to, or affixed to the wheel end assembly 300, so as to provide a visual indication of subjection to higher temperatures. In one embodiment, the visual temperature indicator 304 may comprise a Thermax® temperature indicator or strip which may be affixed, such as by adhesive, to a portion of the wheel end assembly 300, for example the hubcap 302. In another embodiment, the visual temperature indicator 304 may comprise a thermochromic paint 208 applied to the hubcap 302 (as shown in FIG. 3) or other elements of the wheel end assembly 300. In yet another embodiment, the visual temperature indicator 304 may comprise part of, or all of, the hubcap material. The hubcap 302 or a portion thereof may be made of a thermochromic material, such as plastic having thermochromic pigment. Generally, thermochromic plastics and other materials are available for various reference temperatures as identified by different colors that change when the applied temperature becomes substantially equal to or greater than the reference temperature. In other embodiments, the visual temperature indicator 304 may visually indicate exposure to a higher temperature with a change in appearance in addition to a change in color, such as a change to shape, size, orientation or otherwise. The visual temperature indicator 304 may provide a color change with respect to temperature gradient markings so as to indicate an approximate temperature. In another embodiment, the visual temperature indicator 304 may be a clear color or a white color until a predetermined temperature is reached, at which point the visual temperature indicator 304 may change to another color, such as a blue or red color. Additionally, the visual temperature indicator 304 may be easily replaced and/or be capable of transforming between indicating and non-indicating modes, such as by returning to a default color after cooling off. In one embodiment, the visual temperature indicator 304 may comprise a thermochromic ink, paint, paper, polymer, or other suitable element which is connected to an element of the wheel end assembly 300.

The visual temperature indicator 304 may be any suitable size or shape and may be attached to any suitable area in a heat-exchange relationship with the wheel end assembly 300. In FIG. 2, for example, a visual temperature indicator 306 may be affixed to each wheel-end assembly (not shown). Thus, a user may observe the visual temperature indicators to determine which, if any, of the wheel-end assemblies has reached the predetermined temperature. In one embodiment, such as that of FIG. 3, the visual temperature indicator 304 may change from a neutral color to a color that indicates a high temperature so that a driver can easily see if the hubcap 302 has reached the predetermined temperature. Additional visual temperature indicators may be located at different locations 306 and 308 on the wheel end assembly 300 to show whether other components of the wheel end assembly 300 have reached the predetermined temperature. In the embodiment of FIG. 3, the wheel end assembly 300 also includes a visual temperature indicator located at 312 on a surface of the wheel 310 between the lug nuts 314 to show the temperature of the surface of the wheel 310. Of course, only one suitably located visual indicator need be used; however, using more than one may be desirable should one visual indication become detached, or prove defective or damaged.

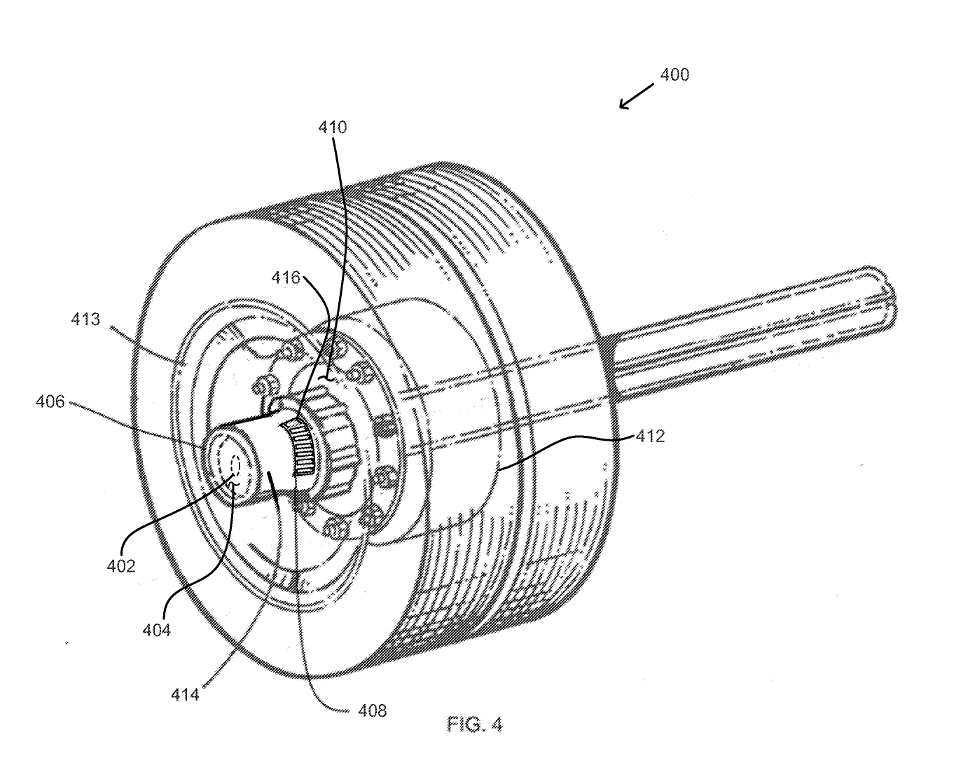

In some embodiments, a visual temperature indicator may include a thermochromic material which is UV-sensitive. As shown in the wheel-end assembly of FIG. 4, the visual temperature indicator 402 may be substantially shielded from UV exposure to reduce the risk of inaccurate temperature readings or degrading the temperature indicator. For example, the visual temperature indicator 402 may be located behind a clear sightglass 404 within an end of the hubcap 406. In other embodiments, the visual temperature indicator 402 may be located on the wheel hub 410, brake drum 412, wheel 413, or other area of the wheel end assembly 400 which is substantially shielded from direct UV exposure. In the embodiment of FIG. 4, a visual temperature indicator 408 may be located on a lateral surface 414 of the hubcap 406. The additional visual temperature indicator 408 may comprise a plurality of thermochromic pigments 416, each of which may change color at a different temperature and may be labeled with a temperature or temperature range at which the pigment changes color. Thus, a user may observe the approximate temperature of the wheel end assembly 400 by viewing which thermochromic pigments 416 have become visible or changed color.

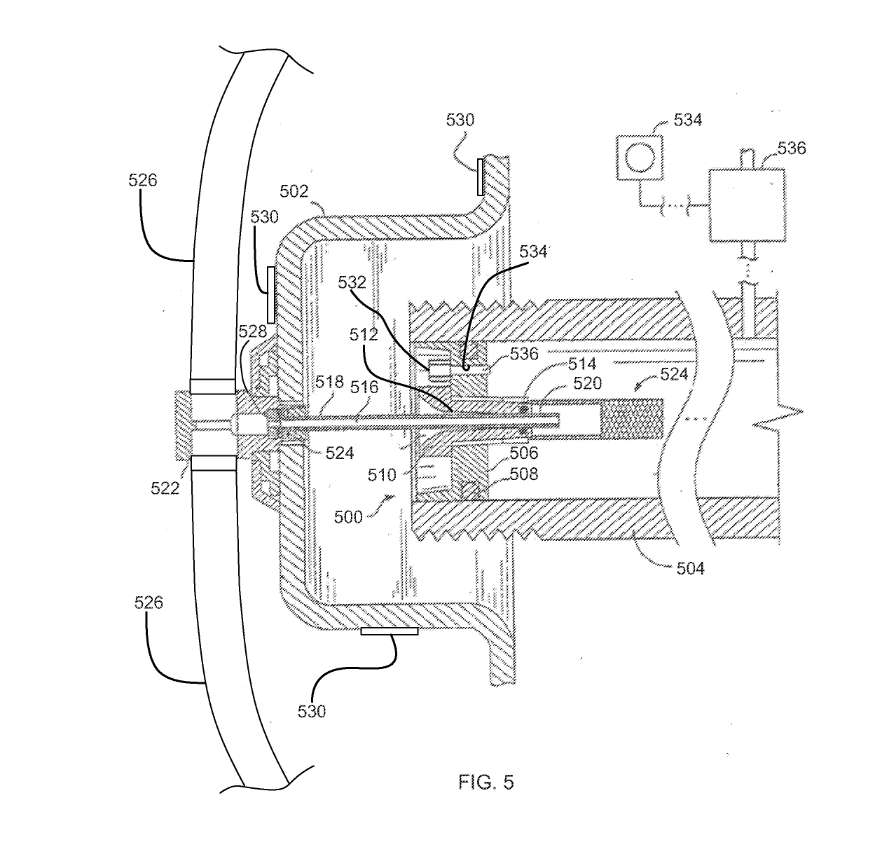

The vehicle 100 of FIGS. 1 and 2 may include both a visual wheel end assembly high-temperature warning system and an automatic tire inflation system. Visual temperature indicators may be located on one or more wheel-end assemblies as described in connection with FIGS. 3 and 4 such that they are still visible to a driver while the air hoses 224, 232 are connected with the air connections 216, 218. For example, FIG. 5 illustrates several embodiments of a wheel end assembly which include both a visual wheel end assembly high-temperature warning system and an automatic tire inflation system. As described above, the automatic tire inflation system may include a pressurized air supply 220 (as shown in FIG. 2) used to provide pressurized air to brakes (not shown) and/or an automatic tire inflation system. While the present invention can be used with various types of automatic tire inflation systems, it is useful with the system shown in FIG. 5 and more fully described and illustrated in U.S. Pat. Nos. 5,769,979 and 6,698,482, both of which are hereby incorporated by reference. Referring to FIG. 5, the reference number 500 generally indicates the rotary air connection for supply air from a pressurized air supply 220 on a vehicle to a rotating tire 206, 208, 210 on a vehicle. A hub cap 502 may be provided at each end of the axle 504 for retaining lubricant in the wheel bearings. The pressurized air supply 220 (as shown in FIG. 2), either directly through the axle 504 or through an interior conduit within the axle 504 (not shown), may supply air to the rotary air connection 500 and then to the rotating tires 206, 208, 210. A force fit plug 506 may be positioned in the center of an end of the axle 504 to sealingly engage the interior of the axle 504 by seal 508 if air is injected directly into the inside of axle 504. The rotary air connection 500 may include a first stationary part 510 having a passageway 512 therethrough. The passageway 512 may be in communication with the pressurized air supply 220 (as shown in FIG. 2). A first resilient rotary seal 514 may be supported in the passageway 512 and may encircle the passageway 512. The rotary air connection 500 may include a second rotatable part including a tubular member 516 having a first end 518 and a second end 520. The second end 520 may be coaxially extendable through and longitudinally and rotationally movable in the passageway 512 and may sealable engage the rotary seal 514. The second end 520 may therefore be in communication with air from the pressurized air supply 220 (as shown in FIG. 2). The first end 518 of tubular member 516 is sealably connected to the air connection 522 on the hub cap 502 through a seal 524. The air connection 522 may be provided on the hub cap 502 for connected to the tire or tires 206, 208, 210 through hoses 526. The first end 518 of the tubular member 516 may include a shoulder which intersects a bearing 528. In operation, air may be supplied through the stationary part 510 to the tubular member 516 and then to the air connection 522 while the hub cap 502 and tires 206, 208, 210 are rotating. In some embodiments, the tubular member 516 may remain substantially stationary while the hub cap 502 and tires 206, 208, 210 rotate. As shown in FIG. 5, visual temperature indicators 530 may be located at different positions on the wheel end assembly and may be positioned so that they are visible while the hoses 526 are attached to the air connection 522. In the embodiment of FIG. 5, visual temperature indicators 530 are attached to a top, lateral side, and flange of the hub cap 502.

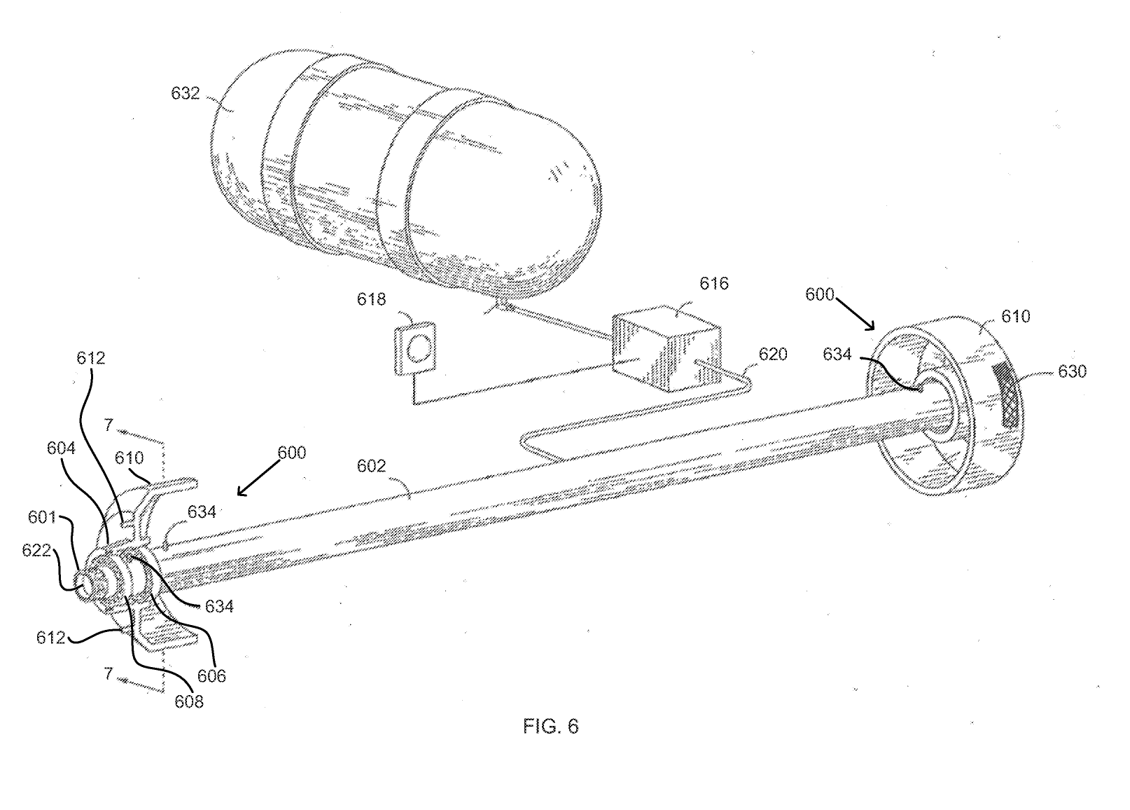

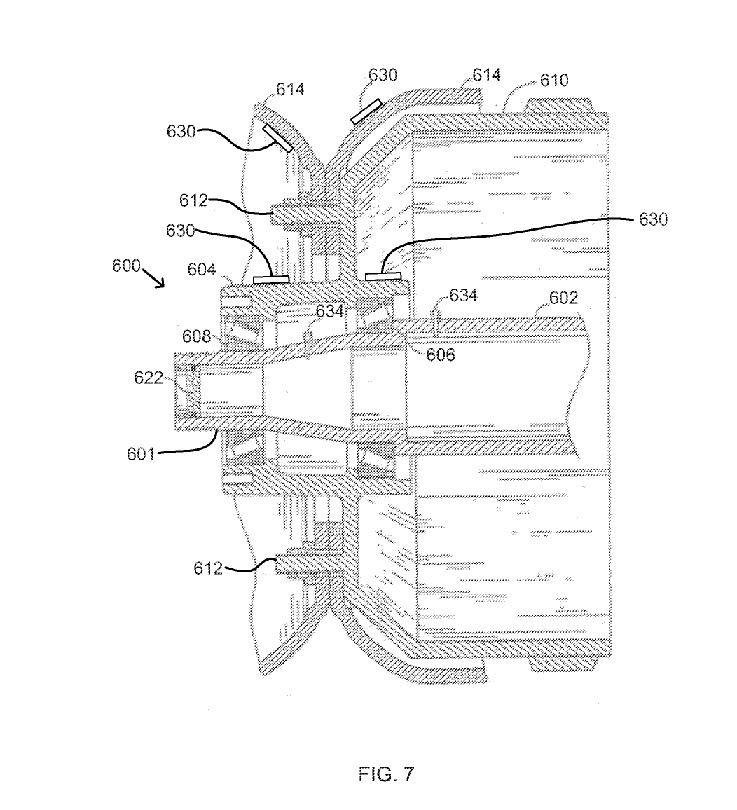

As shown in FIGS. 6-7, the visual wheel end assembly high-temperature warning system may also be used in connection with other high-temperature warning systems, such as the high-temperature warning systems of U.S. Pat. Nos. 6,892,778 and 7,416,005, and PCT Application No. PCT/US11/44879, the disclosures of which are incorporated herein in their entirety by reference. As shown in FIGS. 6-7, a high-temperature warning system may be installed on a vehicle, such as the vehicle 100 of FIG. 1. An exemplary wheel end assembly 600 may be mounted to the spindle 601 of an axle 602, and may include a wheel hub 604 that rotates on inner and outer bearings 606 and 608. The hub 604 may comprise a brake drum 610, and may be include lugs 612 to support one or more wheels 614 having pneumatic tires (not shown) mounted thereto. In the event of a bearing failure or a brake failure, the temperature in the bearings 606 and 608, the brake drum 610 and spindle 601 may increase in temperature at which the tires 110 or bearing lubricant (not shown) may ignite, causing a fire, or the bearings may melt, causing detachment of all or part of the wheel end assembly from the axle.

The high-temperature warning system may, in one embodiment, include a pressurized air supply 632, a pressure regulator and flow switch 616, and a warning system light 618. The pressurized air supply 614 may include the axle 602 which may be hollow and may be connected to the pressurized air supply 614 through air line 620. An axle plug 622 may seal each end of the axle 602 whereby the interior of the axle 602 may form part of the pressurized air supply 614. One or more normally-closed valves 624 may be connected between the inside and the outside of the pressurized air supply 514, including the hollow axle 602 and spindle 601. The normally-closed valves 634 may be configured to make an audible noise when air is allowed to pass through the normally-closed valves 634. The normally-closed valves 634 may be controlled by heat sensitive controls. The heat sensitive controls may be configured to detect temperature and to open the normally-closed valves 634 when a predetermined temperature is reached. Thus, when the temperature near the heat sensitive controls reaches the predetermined temperature the heat sensitive controls may open the normally-closed valves 634 to allow air to pass through the normally-closed valves 634.

The heat sensitive control, in one embodiment, may be a fusible plug 532 (as shown in FIG. 5) comprising an eutectic alloy that seals the normally-closed valve 634. The fusible plug 532 may open the normally-closed valve 634 upon a predetermined temperature by melting sharply at the predetermined temperature and thus un-sealing an aperture 534 (as shown in FIG. 5) that runs through the normally-closed valve 634. Thus, the fusible plug 532 may be automatically removed from the aperture 534 when the predetermined temperature is reached. While any type of fusible plug may be satisfactorily used, one sold under the trademark LEEKPRUF sold by the Mueller Refrigeration Company, Inc., is suitable. In some embodiments, when a normally-closed valve 634 is open, pressurized air is allowed to flow through the normally-closed valve 634. This flow of pressurized air may be detected by a flow switch which actuates the warning system light 618 which is positioned within view of the driver of the vehicle 100 to indicate a problem.

A vehicle may include more than one wheel end assembly. Vehicles such as those shown in FIGS. 1 and 2, for example, may have a wheel-end assembly mounted to the end of each axle, whether a fixed, drive or steer axle. Thus, if a high-temperature wheel-end warning system such as is described in connection with FIGS. 6 and 7 is used, it may not be immediately apparent which wheel end assembly has suffered a temperature sufficiently high to activate the high-temperature warning system. For example, if the eutectic alloy in a fusible plug 532 melts, the releasing air may generate a loud screeching sound. The volume and pitch of such sound may hinder ready identification of which normally-closed valves 634 has opened. Visual temperature indicators may be located on one or more wheel-end assemblies as described in connection with FIGS. 3 and 4 such that they are visible to a driver or maintenance personnel servicing the vehicle. As shown in FIGS. 5-7, for example, visual temperature indicators 530 may be mounted in various locations on the wheels, hub and brake drum to allow a driver or maintenance person to identify the particular wheel-end at a dangerously high temperature.

Referring again to FIG. 5, the wheel end assembly may be equipped with a visual wheel end high-temperature warning system, a high-temperature warning system and an automatic tire inflation system. As illustrated in FIG. 5, air from the pressurized air supply 220 (as shown in FIG. 2) may be supplied through the axle 504 for both the automatic tire inflation system and the high-temperature warning system. Thus, air may be supplied through stationary part 510 to the tubular member 516, to the air connection 522 and then to the hoses 526. Air may be supplied to the rotating tires 206, 208, 210 without expelling air through the aperture 534 because the fusible plug 532 may seal the aperture 534. However, if the fusible plug 532 melts and opens the normally closed value 536, air may be released through the aperture 534 and the flow switch 536 may sense the additional release of air from the pressurized air supply 220. The warning system light 534 may alert the driver that air is being released from the pressurized air supply 220.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition, or matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods or steps.

What is claimed is:

1. A high temperature warning system for a wheel end assembly rotatable on an axle on a vehicle, the system comprising:
an air pressure supply;
a normally-closed valve in sealed fluid communication with the air pressure supply;
a heat sensitive control capable of opening the normally-closed valve upon a predetermined temperature, the heat sensitive control mounted on or near the wheel end assembly in a heat exchange relationship therewith;
a warning indicator connected to the air pressure supply for actuation upon opening of the normally-closed valve; and
a thermochromic temperature indicator affixed to the wheel end assembly in a heat-exchange relationship therewith, the thermochromic temperature indicator capable of changing color when heated to the predetermined temperature.

2. The system of claim 1 wherein the thermochromic temperature indicator comprises a plurality of pigments, each pigment of the plurality of pigments being selected to indicate a different temperature than the other pigment or pigment.

3. The system of claim 1 wherein the thermochromic temperature indicator comprises thermochromic paint.

4. The system of claim 1 wherein the thermochromic temperature indicator affixed to the wheel end assembly is a hubcap comprising thermochromic pigment.

5. An automatic tire inflation system for providing air to a rotating tire on a wheel end assembly rotatably mounted on bearings on a hollow axle, the system comprising:
an air pressure supply for supplying air through the inside of the axle;
a rotary union configured to sealingly communicate air from the inside of the axle to the tire; and
a thermochromic temperature indicator affixed to the wheel end assembly in a heat-exchange relationship therewith, the thermochromic temperature indicator capable of changing color when heated to a predetermined temperature.

6. A high temperature warning system for a wheel end assembly rotatable on an axle on a vehicle, the system comprising:
a wheel end assembly comprising a hub cap, a hub, a wheel, a tire, an axle and bearings;
a temperature indicator affixed at or near the hub cap, hub, wheel, tire, axle or bearings, and in a heat exchange relationship with at least one of the hub cap, hub, wheel, tire, axle and bearings;
wherein the temperature indicator is positioned such that the temperature indicator is visible to a user;
wherein the temperature indicator comprises a thermochromic material; and
wherein the temperature indicator is capable of changing color when heated to the predetermined temperature.
